(19) United States
(12) Patent Application Publication
(10) Pub. No.: US 2014/0196991 A1
(43) Pub. Date: Jul. 17, 2014

(54) Brake Device for Infant Stroller

(71) Applicant: Gregory Fite, Massillon, OH (US)

(72) Inventor: Gregory Fite, Massillon, OH (US)

(21) Appl. No.: 13/910,515

(22) Filed: Jun. 5, 2013

Related U.S. Application Data
(60) Provisional application No. 61/848,753, filed on Jan. 11, 2013.

(51) Int. Cl. B62B 9/08

(52) U.S. Cl. CPC B62B 9/08
USPC 188/69

(57) ABSTRACT

A brake device for use on an infant or child stroller that prevents or stops an unattended stroller from moving by engaging a pin with a socket formed in the side of a wheel when a brake handlebar is released. In a preferred embodiment of the present invention, the brake device is comprised of at least one wheel/brake assembly having a pin and socket configuration, a brake handlebar positioned in close proximity to stroller's handle, and a cable for connecting each wheel/brake assembly to a pivoting brake handlebar. The device enables an operator to disengage the brake device by squeezing the brake handlebar together with the stroller's handle, thus disengaging said pin member from its socket. The brake device can be incorporated into the design of new strollers, as well as, retro-fitted onto existing strollers.

### CROSS-REFERENCE

This application claims priority from Provisional Patent Application Ser. No. 61/848,753 filed on Jan. 11, 2013.

### FIELD OF THE INVENTION

The present invention relates to a brake device for use on an infant stroller. More particularly, the invention relates to brake devices for infant strollers whereby movement of the stroller is restricted when the stroller's brake handlebar is not engaged by the operator.

### BACKGROUND

Infant or baby strollers, also referred to as baby carriages, are well known. Infant strollers typically include a tubular frame, a seat and back portion for holding the infant or small child, and wheels attached to the leg portions of the tubular frame. Further, the infant strollers typically include a handle, formed as a portion of the tubular frame or attached thereto, for pushing the stroller. Prior art strollers come in various configurations including 3-wheeled and 4-wheeled designs, in addition to having foldable and non-foldable types. The rear wheels, and sometimes even the front wheels, of the stroller are equipped with wheel brakes of friction or interlocking types that are typically manually engaged or disengaged by the operator such that when the brake is engaged the wheel rotation is inhibited. The operator wishing to engage the brake usually uses a portion of their foot (i.e., typically the toe-end) to press downward on a lever that engages the brake device. Thus, when the operator engages the manual brake, the stroller movement is inhibited. The parked stroller remains stationary until such time that the operator, again using a portion of their foot, lifts-up on the lever thus disengaging the brake.

In some situations, the operator forgets to engage the manual foot brake on one or more wheels thereby allowing the stroller to move unattended, which could cause injury to the infant or child carried therein. It has also been learned that many of the prior art foot brake devices, found on strollers and the like, fail to meet the durability goals of those who purchase them. The inventor of the present invention, having used and inspected prior art strollers, has discovered that many of the foot brakes found on strollers, either break or become ineffective after some period of time. This too, can lead to an unpredictable safety concern since the operator may believe that the manual foot brake has been engaged, via the pressing down on the lever. However, instead of preventing rotation of the wheel, a malfunctioning prior art brake device may give the operator a false sense of security since the lever portion of the brake device still depresses as normal. The malfunction may occur, at least in part, due to diminishing frictional characteristics of the brake device or due to broken spline members found on an interlocking type of brake device. It is an object of the present invention to overcome both of the above stated safety concerns, as well as others concerns that are typically associated with prior art strollers equipped with a manual foot brake device.

It is also an object of the present invention to provide a wheel brake device for use on an infant stroller that automatically engages one or more wheels when the brake handlebar is released by the operator, and that is robust in design but is also simple to manufacture with as few of additional parts as necessary. Thus, this design will be both attractive and functional for many years of use.

It is another object of the present invention to provide a brake device for use on and infant stroller that has an independent brake engaging means via separate cables attaching to a common brake handlebar. Thus, by having separate brake engaging means at each wheel, a malfunction of one wheel's brake may not inhibit the brake engaging abilities of the remaining brake(s).

It is another object of the present invention to provide a brake device for use on an infant stroller that may be retro-fitted to existing strollers. By replacement of one or more existing wheel/foot brake assemblies on the stroller, manual and/or malfunctioning brake devices can be replaced with the innovative automatic brake design of the present invention. It is contemplated that a complete retro-fit kit could be provided that would include one or more improved wheel/brake assemblies, a brake handlebar with clamping means to the frame, and cables for connecting the wheel/brake assembly to the brake handlebar. Various cable clips of varying diameters could also be included in the kit to accommodate different stroller frame designs.

Consequently, there is a long felt need in the art for an automatic brake device for use on infant strollers that can be either incorporated into the design of new strollers, or be made as a retro-fit kit for use with existing stroller designs. There is also a long felt need for a brake device for use on strollers that is relatively inexpensive to manufacture, and is safe and easy to use, thereby eliminating the safety concerns of using the prior art foot brake designs described herein.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed herein, in one aspect thereof, is a brake device for use on an infant stroller that may be incorporated into the design of new strollers or installed onto existing strollers by replacing one or more existing wheel assemblies with the improved wheel/brake assembly of the present invention, and affixing a brake handlebar to the stroller frame. In a preferred embodiment of the present invention, the brake device is comprised of a pair of wheel/brake assemblies, a brake handlebar and a pair of frame connectors for attaching the handlebar to the frame, a pair of cables for connecting each wheel/brake assembly to the brake handlebar, and a plurality of cable support clips for securing the cables to the stroller frame. In a preferred embodiment of the present invention, each wheel/brake assembly will be affixed to the end of a rear leg of the stroller, using the same or similar connection means as what was used on the original wheel assembly. This could include spring-actuated detents, fasteners, press-fits, adhesives, or the like.

The brake device enables an operator to (i) securely park an infant stroller by simply letting go of the brake handlebar without the need to affirmatively engage a foot brake of the like; and (ii) to bring a moving stroller to a stationary position in a safe manner. Both modes of operation are accomplished by the present invention's ability to automatically stop the wheel when the brake handlebar is released. Finally, the brake device of the present invention is relatively inexpensive to manufacture, and safe and easy to install and use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a perspective view of a prior art stroller.

FIG. 2 is a perspective view of a preferred embodiment of the brake device of the present invention installed on the rear legs of a prior art stroller and having the brake handlebar assembly affixed to the stroller frame near the stroller handle, and is shown in a brake engaged position.

FIG. 3A is a perspective close-up view of a preferred embodiment of the brake device of the present invention depicting a portion of the brake handlebar including a section of cable attached thereto, installed on the stroller frame near the stroller handle, and is shown in a brake engaged position.

FIG. 3B is a perspective close-up view of a preferred embodiment of the brake device of the present invention depicting a wheel/brake assembly including a section of cable attached thereto, installed on a rear leg portion of the frame, and is shown in a brake engaged position.

FIG. 4 is a perspective partial-exploded view of a preferred embodiment of the handlebar assembly including a section of cable attached thereto, and is shown in a brake engaged position.

FIG. 5 is a perspective exploded view of a preferred embodiment of the inboard and outboard connectors used for affixing the brake handlebar of the present invention to the stroller frame as depicted in FIGS. 3A and 4 herein.

FIG. 6 is a perspective exploded view of a preferred embodiment of the wheel/brake assembly and portion of cable attached thereto.

FIG. 7A is a partial sectional view of a preferred embodiment of the wheel/brake assembly including a section of cable attached thereto, and is shown in a brake engaged position.

FIG. 7B is a partial sectional view of a preferred embodiment of the wheel/brake assembly including a section of cable attached thereto, and is shown in a brake disengaged position.

FIG. 8 is a perspective view of a preferred embodiment of the brake device of the present invention shown as a retro-fit kit representation, depicting the components commonly provided therein.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

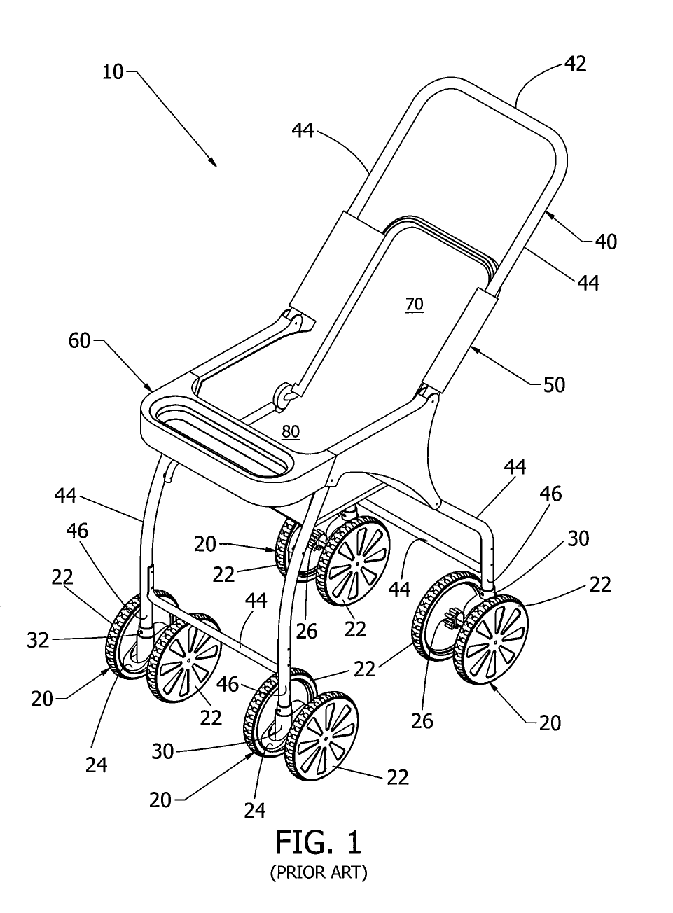

Referring initially to the drawings and by way of background, FIG. 1 illustrates a perspective view of a prior art infant stroller 10. Prior art strollers 10 are well known in the art and are available in various shapes, sizes and designs. Nonetheless, most prior art strollers 10 are generally comprised of a frame 40 having one or more tubular members 44. Typically, a portion of the frame 40 forms a handle 42 for the operator (not shown) to push or pull the stroller 10. The stroller 10 typically includes three or four legs 46 formed as part of the frame 40. Prior art wheel assembly 20 attaches to the end of each leg 46 via aperture 32, which can be any number of well-known in the art fastening means including spring-actuated detents, fasteners, or rivets. Prior art housing 30 is sized appropriately to slide over the end of leg 46 and secured by aperture 32. Alternatively, prior art housing 30 could be held in place by other means other than aperture 32, for instance, the prior art housing 30 could be press-fit over leg 46, and additionally secured using an adhesive between the two said components.

FIG. 1 further illustrates a stroller 10 having prior art wheel assemblies 20 each configured with two rotatable wheels 22. Each wheel 22 is pivotally attached to prior art wheel housing 30. Many prior art strollers 10 include a foot brake 24 integral to one or more of the prior art wheel housings 30. By pressing downward on foot brake 24, prior art foot brake devices typically either apply a frictional force to wheel 22 or use an interlocking mechanism, including a spline 26 attached to the side of wheel 22, to inhibit the rotation of the wheel 22.

Prior art strollers 10 also include a seat 80 and back rest 70 formed by various tubular members 44 of the frame 40. Cloth 50 covers a portion of the frame 40 to form seat 80 and back 70. Removable tray 60 may also be incorporated into the design of the stroller 10 to facilitate getting the infant or small child into or out of the stroller 10. Other features typically present prior art strollers 10 may include the ability to fold the stroller for easier storage, and may also include stroller bins for holding toys and other items.

Nonetheless, as previously stated, there is a long felt need in the art for an improved brake device for use on strollers that can be either incorporated into the design of new strollers, or be made as a retro-fit kit on existing stroller designs. There is also a long felt need for a brake device for use on strollers that is relatively inexpensive to manufacture, and is safe and easy to use, thereby eliminating the safety concerns associated with prior art foot brake designs.

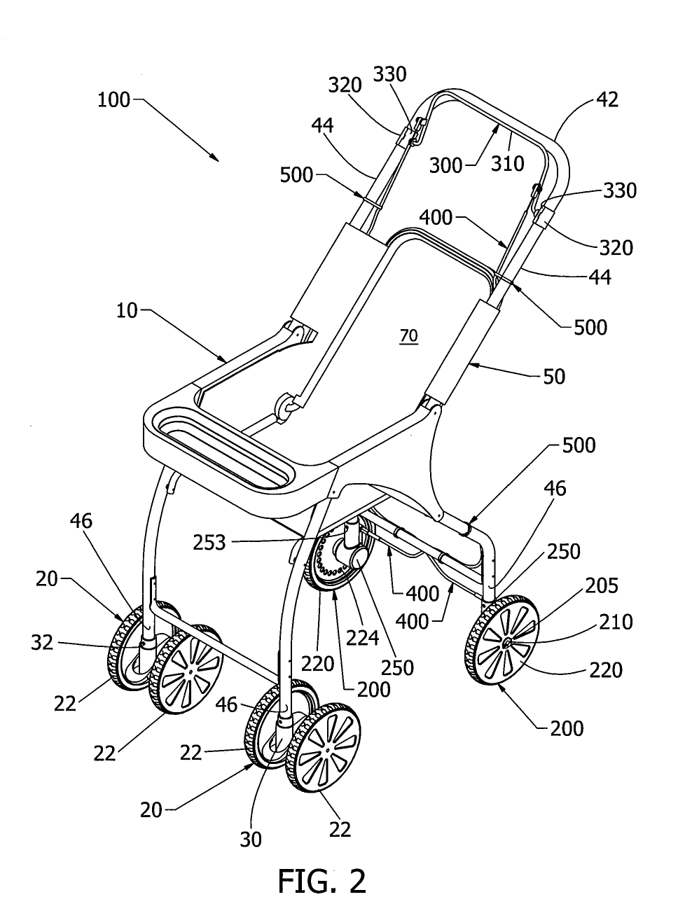

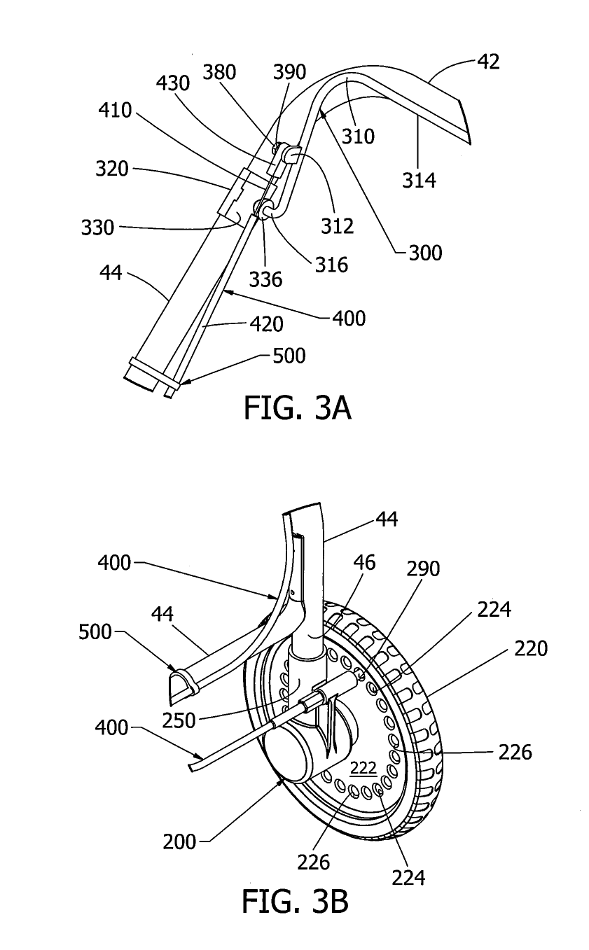

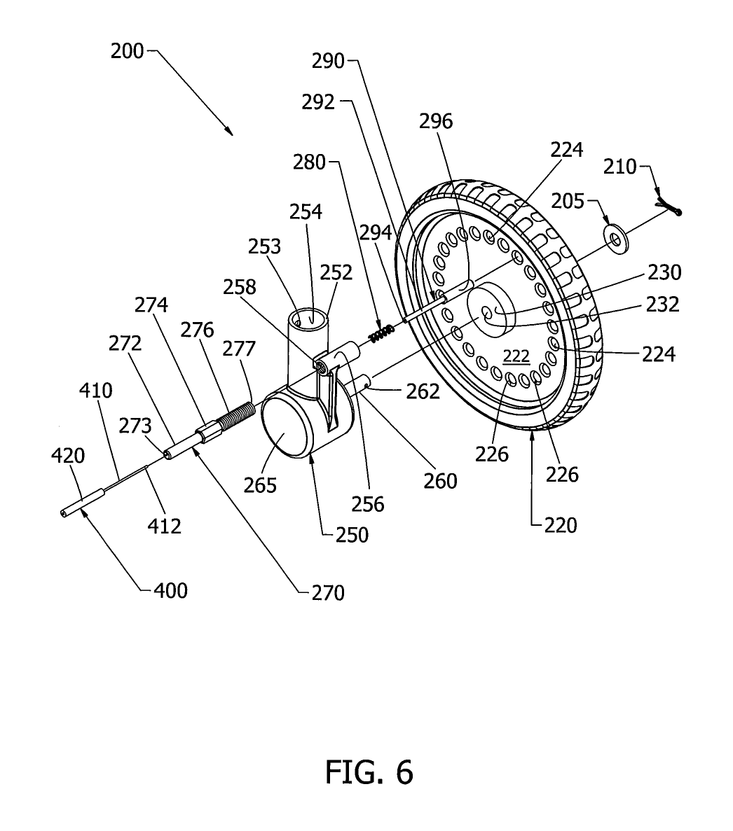

FIG. 2 is a perspective view of a preferred embodiment of the wheel/brake assembly 200 of the present invention installed on the rear legs 46 of a prior art stroller 10 and having the brake handlebar assembly 300 affixed to the stroller frame 40 near the stroller handle 42, as explained more fully below. Improved brake device 100 as depicted in FIG. 2, shown in a brake engaged position, includes a wheel/brake assembly 200 preferably installed onto each of rear legs 46 of stroller 10. Wheel/brake assembly 200 includes at least one improved wheel 220 that is pivotally mounted to improved housing 250. Attachment of improved housing 250 onto leg 46 is similar to that as previously described for prior art housing 30. Briefly stated again, improved housing 250 is sized appropriately so that it can slide over the end of leg 46 and is secured thereto preferably by aperture 253, or any of the other methods previously described herein. Improved wheel 220 pivotally mounts to improved housing 250 via axle portion 260 and is secured using washer 205 and cotter pin 210, which is more fully described below and shown in FIG. 6. Alternatively, improved wheel 220 could be secured using other commonly known methods such as threaded fasteners, press-on fasteners, or the like. A plurality of pin sockets 224 are shown in a spaced apart radial pattern, spaced around the inboard side 222 of improved wheel 220 for purpose of receiving pin 290 (see FIGS. 3B and 6).

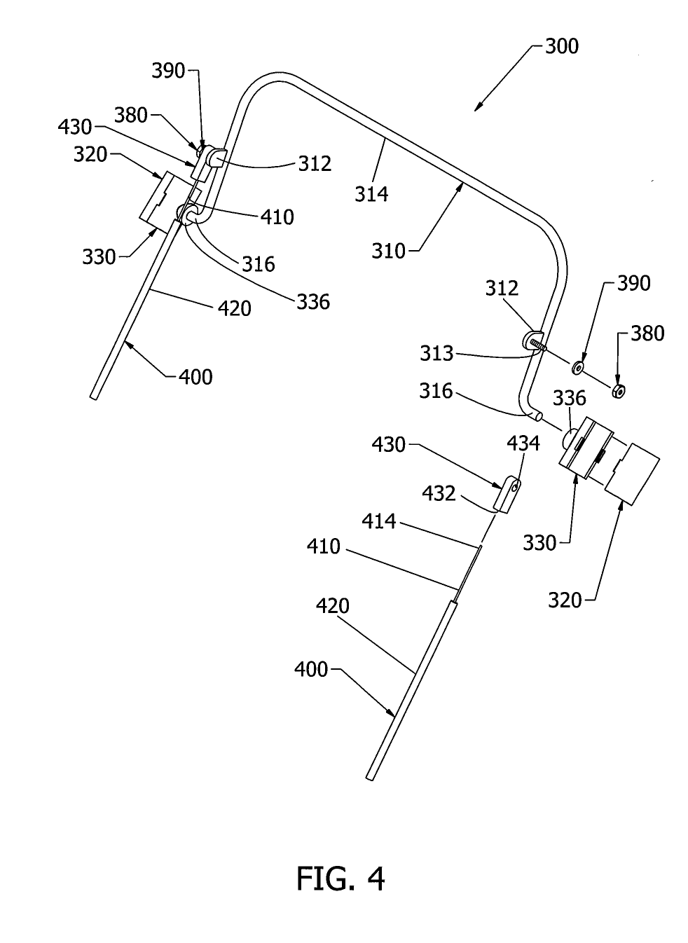

Each cable 400 is preferably connected at wire (pin) end 412 to wheel/brake assembly 200 and is secured to stroller 10 via one or more cable support clips 500, which are sized appropriately to snap onto (or over) tubular member 44, and are typically made from plastic or other suitable materials. The opposite end of each cable 400 is attached to handlebar assembly 300. In a preferred embodiment, the wire (handlebar) end 414 of cable 400 is pivotally attached to brake handlebar 310, which is more fully described in FIGS. 3A and 4 herein.

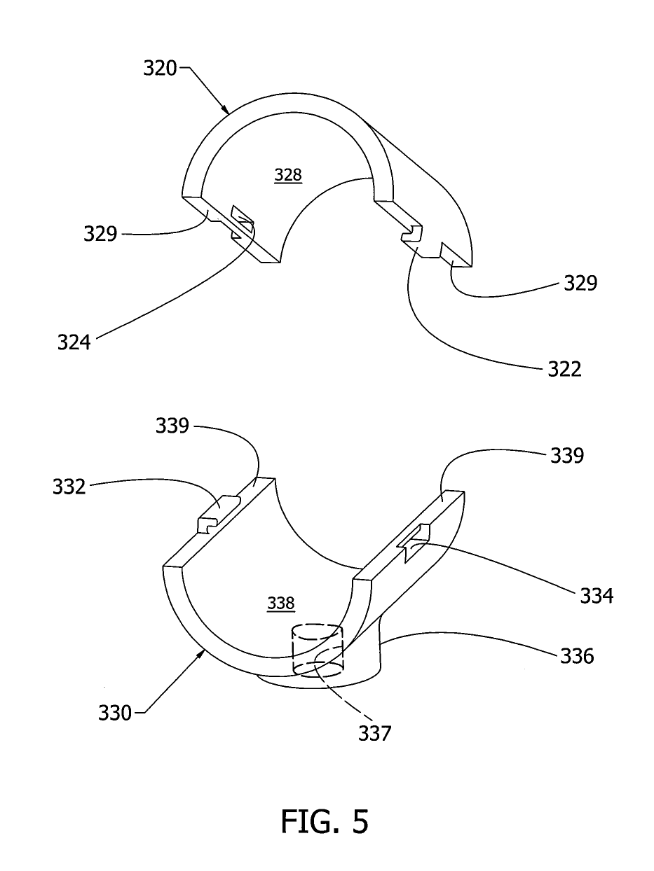

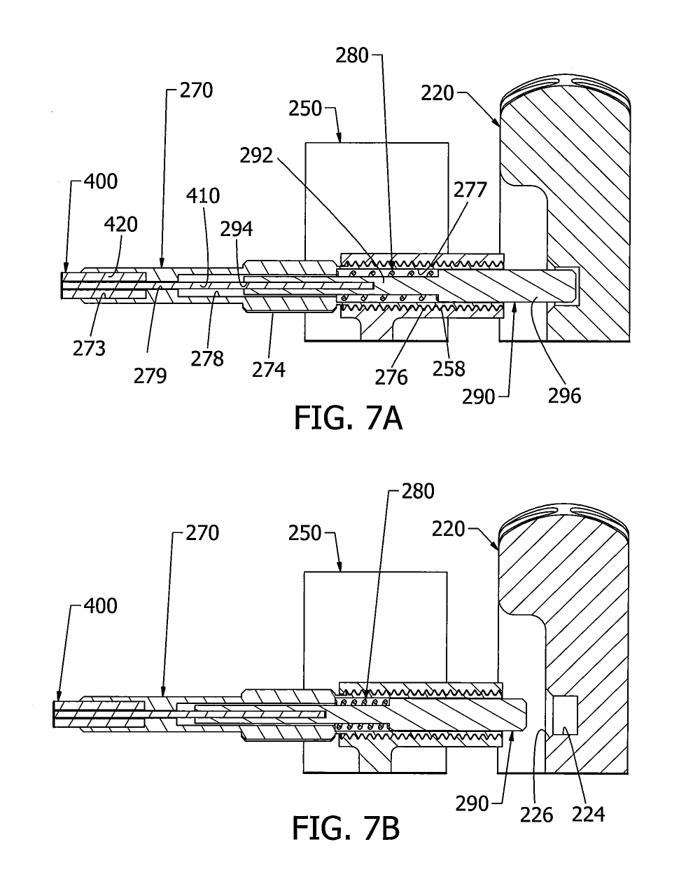

FIG. 2 shows handlebar assembly 300 preferably attached to side tubular members 44 such that grip 314 (see FIG. 3A) of brake handlebar 310 is in close proximity to stroller handle 42 for common gripping of both members by the operator (not shown). The attachment of handlebar assembly 300 is preferably made by frictional attachment of outboard connector 320 and inboard connector 330 having a preferred snap-fit assembly around a portion of tubular member 44, which is more fully described in FIG. 5. In the brake engaged position, as shown in FIGS. 2 and 3A, grip 314 is spaced way from handle 42. Tension wire 410 running internal throughout cable 400, acts on brake handlebar 310 as a result of compression spring 280 acting on pin 290 (see FIG. 6). In this position, pin 290 is engaged with or inserted into pin socket 224, thus inhibiting further forward or backward movement of improved wheel 220. The operator can disengage the improved brake device 100 by grasping brake handlebar 310 and squeezing it such that grip 310 contacts (or moves in a direction towards) handle 42 in a preferred embodiment. See FIGS. 7A and 7B for more details on engagement and disengagement of the improved brake device 100.

FIG. 3A is a perspective close-up view of a preferred embodiment of the improved brake device 100 of the present invention depicting a portion of the brake handlebar 310, including a section of cable 400 attached thereto, installed on the stroller frame 40 near the stroller handle 42, and is shown in a brake engaged position. Handlebar assembly 300 is shown in a close-up partial-view in the figure. Details described below for one side of handlebar assembly 300 will be preferably similar to the opposite side of handlebar assembly 300 (also see FIG. 4). Brake handlebar 310 includes a grip 314 for the operator (not shown) to grasp. Brake handlebar 310 preferably includes a bracket 312 located between grip 314 and pivot end 316. Bracket 312 is affixed to brake handlebar 310 by welding, soldering, brazing, adhesives, fasteners, or the like. Bracket 312 includes a threaded portion 313 (see FIG. 4) to pivotally support cable connector 430, and is secured by cable connector washer 390 and cable connector nut 380 via opening 434 in cable connector 430. Wire (handlebar) end 414 is secured to cable connector 430, via opening 432 (see FIG. 4), by any suitable means such as crimping, soldering, fastening, or the like. Cable connector 430 and tension wire 410 are preferably both made from metal or other suitable materials. Tension wire 410 is typically encased inside of casing 420, which can be made from plastic or other suitable materials. Tension wire 410 is typically free to slide within casing 420. Cable 400 is well-known in the art, and typically has a section on each end that is free from casing 420, and is secured to the tubular member 44 by cable support clips 500. In the present invention there is preferably one cable 400 for each wheel/brake assembly 200, having ends 412 and 414. In this configuration, each wheel/brake assembly 200 acts independent from one another, thereby adding another safety feature to the present invention. However, it is envisioned that each cable 400 could be separately attached to wheel/brake assembly 200, and then, joined together at a common location on brake handlebar 310.

Brake handlebar 310 is preferably constructed from metal having an approximate cross-section diameter of 0.250 inches. However, other materials such as plastic or wood could also be considered, in addition to other cross-sectional shapes and sizes as long as grip 314 is still able to be comfortably squeezed, along with handle 42, by operator (not shown). Brake handlebar 310 is preferably constructed having a pivot end 316 on each end for pivotally attaching to tubular member 44 via outboard connector 320 and inboard connector 330. In a preferred embodiment, inboard connector 330 includes an opening 337 (see FIG. 5) in the handlebar mount 336 portion of said connector appropriately sized to fit pivot end 316 of brake handlebar 310 (see FIG. 5). Handlebar mount 336 provides pivotal support for each end of brake handlebar 310. Additionally, inboard connector 330 has clamping surface 338 complimentarily shaped and sized to fit tightly against tubular member 44 when joined together with outboard connector 320. Outboard connector 320 also has clamping surface 328 complimentarily shaped and sized to fit tightly against tubular member 44 when joined together along mating surfaces 329 with inboard connector 330 along its mating surfaces 339. Inboard connector 330 has one or more tabs 332 complimentary sized and shaped to fit one or more slots 324 on outboard connector 320. Likewise, outboard connector 320 has one or more tabs 322 complimentary sized and shaped to fit one or more slots 334 on outboard connector 330. Both sets of tab/slots are configured to snap together and hold the brake handlebar 310 in place on frame 40.

FIG. 5 is a perspective exploded view of a preferred embodiment of the inboard connector 330 and outboard connector 320 used for affixing the brake handlebar 310 of the present invention to the frame 40 as depicted in FIGS. 3A and 4 herein. Both connectors can be made from metal, plastic, or other suitable materials. In addition, other means of attaching brake handlebar 310 to frame 40 are to be considered as well. For instance, it is envisioned that an opening in tubular member 44 could be sized appropriately to accommodate each pivot end 316 of handlebar 310. Openings in tubular member 44 may be preferable on the design and manufacture of new strollers having the improved brake device 100 integrated into the overall design, whereas, inboard/outboard connectors may be preferable on retro-fit kit designs.

FIG. 4 is a perspective partial-exploded view of a preferred embodiment of the handlebar assembly 310 including a section of cable 400 attached thereto, and has been described above by way of the description of FIGS. 3A and 5.

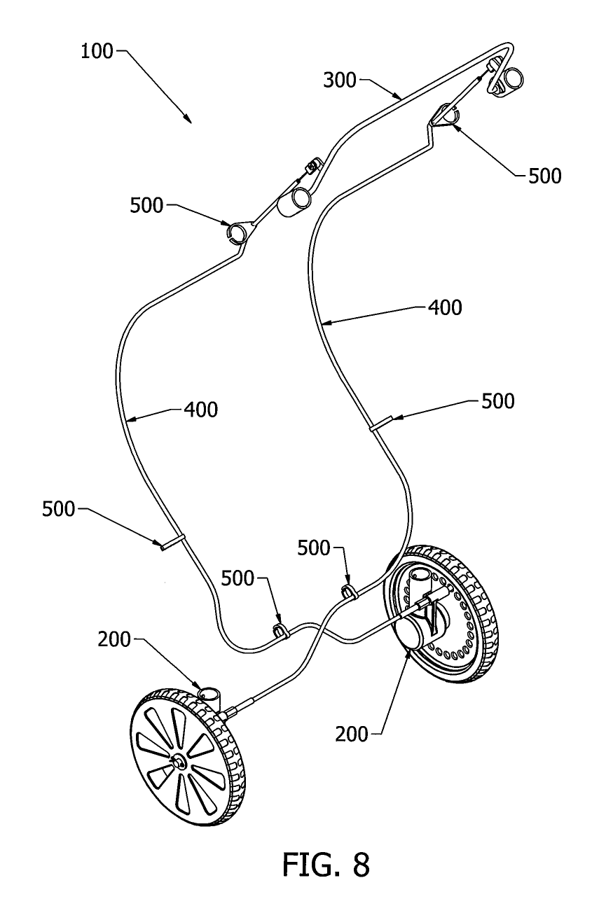

FIG. 3B is a perspective close-up view of a preferred embodiment of the improved brake device 100 of the present invention depicting a wheel/brake assembly 200, including a section of cable 400 attached thereto, installed on a rear leg 46 portion of the frame 40, and is shown in a brake engaged position. An additional section of cable 400 is also shown in the figure, which is attached to the wheel/brake assembly 200 on the opposite rear leg 46 (see FIG. 2 or 8). Each cable 400 is preferably connected at wire (pin) end 412 to wheel/brake assembly 200 and is secured to stroller 10 via one or more cable support clips 500, which are sized appropriately to snap onto (or over) tubular member 44, and are typically made from plastic or other suitable materials.

Improved housing 250, made from metal, plastic, or other suitable material, includes a leg receiving portion 252, spring seat receiving portion 256, axle portion 260, and a body portion 265, all of which will be described in more detail in the description for FIG. 6 below. Leg receiving portion 252 is appropriately sized and shaped to slide over leg 46 and is attached using any of the methods previously described herein.

Improved wheel 220 is of similar construction to that of the prior art wheel 22, also being constructed of similar materials as well. Such materials include: plastic, metal, wood, or rubber. The primary difference between improved wheel 220 and prior art wheel 22 has to do with the improved interlocking feature found on the present invention, namely a plurality of radially spaced pin sockets 224 formed in the inboard side 222 of improved wheel 220. Pin socket 224 is sized and shaped to accommodate enlarged portion 296 of pin 290. Pin socket 224 preferably has a diameter of about 0.3 inches. In the preferred embodiment, improved wheel 222 includes 25 radially spaced pin sockets 224, centered about hub 230. Opening 232 formed in the center of hub 230 is sized appropriately to freely slide over axle portion 260 of improved housing 250. It is also envisioned that hub 230 could also include bearing member (not shown) sized to fit inside opening 232 and onto axle portion 260.

Pin 290 includes an enlarged portion 296 having an approximate diameter of 0.250 inches for insertion into pin socket 224. Pin 290 can be made of metal or other suitable materials such as plastic, provided the material selection for pin 290 will meet the durability goals set forth herein, and thereby, resist breaking or deforming during use. The actual number of radially spaced pin sockets 224, size and shape of pin socket 224, and size and shape of enlarged portion 296 of pin 290 can be varied and still achieve the goals of the present invention. The actual acceptable range for each is geometrically interrelated, and can be varied. An important consideration is that adequate clearance between pin socket 224 and enlarged portion 296 of pin 290 is desired so that pin 290 engages a pin socket 224 efficiently, thereby, stopping the rotation of improved wheel 220. A further improvement to the shape of the pin socket 224, as shown in the present invention, is the addition of chamfered portion 226, which may facilitate even faster pin/socket engagement. It is envisioned that chamfered portion 226 could be made as a chamfer, radius, or the like, having a similar profile to that of the corresponding pin socket 224.

FIG. 6 is a perspective exploded view of a preferred embodiment of the wheel/brake assembly 200 and portion of cable 400 attached thereto. Improved housing 250 includes a leg receiving portion 252, spring seat receiving portion 256, axle portion 260, and a body portion 265. Body portion 265 provides structural integrity and common connection to: leg receiving portion 252, spring seat receiving portion 256, and axle portion 260. Leg receiving portion 252 has appropriately sized and shaped opening 254 to slide over leg 46, and includes aperture 253 that may be used to secure wheel/brake assembly 200 to leg 46, as previously described herein. Spring seat receiving portion 256 has threaded portion 258 therein for receiving and fastening spring seat 270 via its threaded portion 276. Axle portion 260 is sized appropriately to pivotally attach improved wheel 220, and may include aperture 262 for receiving cotter pin 210. Additionally, washer 205 may be placed onto axle portion 260 between improved wheel 220 and cotter pin 210.

Spring seat 270 includes cable receiving portion 272, a hex portion 274, and threaded portion 276. Cable receiving portion 272 has opening 273 sized to accommodate casing 420 typically found on well-known in the art cable 400. A portion of tension wire 410 will extend through a reduced opening 279 (see FIG. 7A) sized to allow free sliding movement of tension wire 410, but smaller in diameter than that of casing 420. Hex portion 274 is shown preferably having six flat surfaces to accommodate a standard wrench for tightening or loosening the attachment of spring seat 270 to improved housing 250. Threaded portion 276, in addition to its previous description, also includes enlarged opening 277 sized appropriately to allow enlarged portion 296 of pin 290 to slide freely therein.

Spring 280 is sized to fit inside enlarged opening 277 as well, and is preferably comprised of metal. In the preferred embodiment, spring 280 has a spring force of approximately one pound in the unbiased position and approximately four pounds in the biased position. Nonetheless, it is contemplated that other spring forces could also be used without affecting the overall concept of the invention. Spring seat 270 is typically made from metal, plastic, or other suitable materials.

Pin 290 includes cable receiving portion 292 and enlarged portion 296. Cable receiving portion 292 is sized appropriately such that spring 280 can slide freely over it. In addition, cable receiving portion 292 also has opening 294 therein for securely fastening wire (pin) end 412 by any suitable means such as crimping, soldering, fastening, or the like. Pin 290, including enlarged portion 296, has previously been described in the section on FIG. 3B.

FIGS. 7A and 7B are a partial sectional view of a preferred embodiment of the wheel/brake assembly 200 including a section of cable 400 attached thereto, and is shown in a brake engaged position and brake disengaged position, respectively. Many of the details of the various components have already been discussed herein. The description below, using FIGS. 7A and 7B, will describe the movement of the various components during a brake disengagement event, and a brake engagement event. Total movement of pin 290 can be defined by comparing its position within the improved housing 250 when the brake is engaged (see FIG. 7A) and when the brake is disengaged (see FIG. 7B). It should be noted that total movement of pin 290 is preferably about 0.375 inches, but can also range between 0.250 and 0.500 inches, and possibly more. The acceptable range of total movement of pin 290 is such that, at a minimum, pin 290 needs to be fully disengaged from pin socket 224; and at a maximum, grip 316 needs to be at a comfortable position relative to handle 42.

During disengagement of the improved brake device 100, pin 290 is retracted in an inboard direction. Since the length of spring 280 is confined between the end of the enlarged portion 296 of pin 290 and end of the enlarged opening 277 formed within spring seat 270, its compressed length will be determined by the position of pin 290. A shortened spring length, as shown in FIG. 7B, will lead to increased force stored within spring 280. Opening 278 formed within spring seat 270 is sized appropriately so that cable receiving portion 292 of pin 290 is permitted to slide freely within the limits of total movement of the pin 290.

FIG. 8 is a perspective view of a preferred embodiment of the brake device 100 of the present invention shown as a retro-fit kit representation, depicting the components commonly provided therein. One important aspect of the present invention is that it can be easily made as a retro-fit kit, installable onto existing strollers 10. The installer (not shown) will typically remove the two rear prior art wheel assemblies 20 from existing stroller 10. Next, the installer will affix a new wheel/brake assembly 200 to each of the rear legs 46, using any one of the attachment means previously discussed herein. Next, the installer will route each of the cable 400 sections along the frame 40 so that cable 400 is supported by tubular members 44, using cable support clips 500, making sure that the cable 400 is not bent too tightly as to restrict tension wire 410 movement within casing 420.

The kit described herein may include one handlebar assembly 300 and two wheel/brake assemblies 200. In addition, cable 400 can be either supplied already attached to handlebar assembly 300 and wheel/brake assemblies 200 as shown in the figure, or can be supplied separately so that the installer can custom-fit the proper amount of cable for the stroller during installation. Cable support clips 500 may be included either preinstalled on each cable 400, or supplied separately; and may come in different sizes to accommodate different diameters of tubular members 44.

The figures herein show a preferred path for routing cable 400 from right hand side wheel/brake assembly 200 across a lateral tubular member 44, then attaching to left hand side of stroller's tubular member 44 to attach to the left hand side of handlebar assembly 300. This is only one cable routing path, and it is also envisioned that cables could be routed such that right hand wheel/brake assembly 200 attaches to right hand side of handlebar assembly 300. Further, it is also envisioned that wheel/brake assemblies 200 could be installed onto the front stroller legs 46 instead of the rear legs 46. Additional wheel/brake assemblies 200 could also be added to each of the legs 46 of the stroller 10 by simply adding additional wheel/brake assemblies 200 and cables 400 as desired. Additional wire (handlebar) ends 414 could be attached to handlebar assembly 300 in a similar manner as previously described.

In use, the improved brake device 100, either incorporated into the design of a new stroller 10 or the retro-fitting of an existing stroller 10, can easily be utilized for stopping or parking an unattended stroller. The force due to the compression of spring 280 urges the movement of pin 290 in an outward direction until pin 290 successfully engages (or is inserted into) a pin socket 224, which is formed within the inboard side 222 of improved wheel 220. When this occurs, the forward and backward rotation of improved wheel 220 is prevented. Simultaneously, the movement of pin 290 pulls on wire (pin) end 412, which causes the entire length of tension wire 410 to slide within casing 420. The motion of tension wire 410 includes the movement of cable connector 430. Thus, the translational movement of cable connector 430 causes a slight pivotal rotation of brake handlebar 310 about pivot ends 316 in a direction away from handle 42.

When an operator (not shown) grasps grip 314 of the brake handlebar 310 and squeezes it together along with handle 42, a slight rotation of brake handlebar 310 about pivot ends 316 will occur. However, this time, the translational movement of cable connector 430 will be in an opposite direction as previously described. This movement will then be transferred along the entire length of tension wire 410, thus sliding within casing 420 in a direction opposite as well. Simultaneously, pin 290 will move in an inboard direction due to its attachment to wire (pin) end 412 of tension wire 410. Movement of pin 290 inward then causes pin 290 to become disengaged from pin socket 224, thus allowing rotation of improved wheel 220 to occur when operator of the stroller pushes or pulls onto handle 42 of stroller 10. Spring 280 is now in a more compressed position, and has increased force to urge pin 290 back into an engaged position upon releasing of brake handlebar 310. Thus, spring 280 needs to be properly sized such that when brake handlebar 310 is released, it will have sufficient force to properly engage the improved brake device 100; but not too much force such that squeezing the grip 314 and handle 42 would be difficult to accomplish.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A brake device for a stroller comprising:
a brake handlebar repositionable between an engaged position and a disengaged position;
at least one brake assembly further comprised of a repositionable pin;
at least one cable connecting said brake handlebar to said repositionable pin; and
at least one wheel assembly further comprised of a wheel and a plurality of spaced apart pin sockets for receipt of said repositionable pin.

2. The brake device of claim 1 further comprising at least one support clip for attaching said at least one cable to a stroller frame.

3. The brake device of claim 1 wherein said repositionable pin is inserted into one of said plurality of spaced apart pin sockets when the brake handlebar is in the engaged position and further wherein said repositionable pin is retracted from said one of said plurality of spaced apart pin sockets when the brake handlebar is in the disengaged position.

4. The brake device of claim 1 wherein said plurality of spaced apart pin sockets form a generally circular pattern on an inboard surface of said wheel.

5. The brake device of claim 1 wherein said stroller further comprises a handle for pushing said stroller, and further wherein said brake handlebar is positioned adjacent to said handle.

6. The brake device of claim 1 wherein said brake handlebar remains in the engaged position until repositioned into the disengaged position by an operator.

7. The brake device of claim 1 wherein said at least one brake assembly further comprises a spring to facilitate the movement of repositionable pin, and further wherein said spring is unbiased when the brake handlebar is in the engaged position.

8. The brake device of claim 1 wherein said at least one brake assembly further comprises a spring to facilitate the movement of repositionable pin, and further wherein said spring is biased when the brake handlebar is in the disengaged position.

9. The brake device of claim 1 wherein said at least one cable is further comprised of a length of wire at least partially encased in a protective casing.

10. A brake device for a stroller comprising:
a brake handlebar;
a first brake assembly comprised of a first repositionable pin;
a second brake assembly comprised of a second repositionable pin;
a first cable connecting said brake handlebar to said first brake assembly;
a second cable connecting said brake handlebar to said second brake assembly;
a first wheel assembly comprised of a first wheel with a first plurality of spaced apart pin sockets thereon; and
a second wheel assembly comprised of a second wheel with a second plurality of spaced apart pin sockets thereon.

11. The brake device of claim 10 further comprising at least one support clip for attaching said first cable to a stroller frame and at least one additional support clip for attaching said second cable to said stroller frame.

12. The brake device of claim 10 wherein said first repositionable pin is inserted into one of said first plurality of spaced apart pin sockets and said second repositionable pin is inserted into one of said second plurality of spaced apart pin sockets when the brake handlebar is in the engaged position, and further wherein said first repositionable pin is retracted from said one of said first plurality of spaced apart pin sockets and said second repositionable pin is retracted from said one of said second plurality of spaced apart pin sockets when the brake handlebar is in the disengaged position.

13. The brake device of claim 10 wherein the first plurality of spaced apart pin sockets form a generally circular pattern on an inboard surface of said first wheel and the second plurality of spaced apart pin sockets form a generally circular pattern on an inboard surface of said second wheel.

14. The brake device of claim 10 wherein said stroller further comprises a handle for pushing said stroller, and further wherein said brake handlebar is positioned adjacent to said handle.

15. The brake device of claim 10 wherein said brake handlebar remains in the engaged position until repositioned into the disengaged position by an operator.

16. The brake device of claim 10 wherein said first brake assembly further comprises a spring to facilitate the movement of first repositionable pin, and further wherein said spring is unbiased when the brake handlebar is in the engaged position.

17. The brake device of claim 10 wherein each of said first brake assembly and said second brake assembly further comprise a spring, and further wherein each of said springs is biased when the brake handlebar is in the disengaged position.

18. A kit for retrofitting an existing stroller with a braking mechanism, wherein said kit comprises:
a brake handlebar assembly repositionable between an engaged position and a disengaged position;
a pair of brake assemblies, wherein each of said pair of brake assemblies further comprises a repositionable pin;
at least one cable operably connecting said brake handlebar to each of said pair of brake assemblies;
at least one support clip for attaching said at least one cable to a frame on the existing stroller; and
a pair of wheel assemblies, wherein each of said pair of wheel assemblies further comprises a wheel with an inboard surface and a plurality of spaced apart sockets on said inboard surface.

19. The kit of claim 18 wherein each of said brake assemblies further comprise a spring to facilitate the movement of the repositionable pin, and further wherein said spring is unbiased when the brake handlebar is in the engaged position.

20. The kit of claim 18 further comprising at least one connector for attaching said brake handlebar to a frame of the existing stroller, and further wherein said plurality of spaced apart sockets form a generally circular pattern on the inboard surface.
